(19) United States
(12) Patent Application Publication
(10) Pub. No.: US 2010/0284396 A1
(43) Pub. Date: Nov. 11, 2010

(54) Communication system and method

(76) Inventor: Peter A. Kalmstrom, Norrkoping (SE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/387,970

(22) Filed: May 8, 2009

(51) Int. Cl. H04L 12/66; G06F 3/048; G06F 15/16

(52) U.S. Cl. 370/352; 715/738; 709/228; 709/206

(57) ABSTRACT

A method, program and system for use in a communication system comprising at least a packet-based network. The method comprises: receiving names of users of the communication system retrieved from a first storage unit; and interacting with a document-browser application executed on a first user terminal, the document browser being configured to retrieve an electronic document from a second storage unit and display it on a screen, the document comprising at least a portion of text; wherein said interaction comprises analysing the text of the retrieved document in order to match one or more of said names with one or more respective corresponding text strings in said document, and displaying presence information in conjunction with the document to indicate an availability status of the user corresponding to the matched name.

### TECHNICAL FIELD

The present invention relates to communicating over a packet-based network.

### BACKGROUND

Some communication systems allow the user of a device, such as a personal computer, to communicate across a packet-based computer network such as the Internet. Such communication systems include voice over internet protocol (“VoIP”) communication systems. These systems are beneficial to the user as they are often of significantly lower cost than conventional fixed line or mobile networks. This may particularly be the case for long-distance communication. To use a VoIP system, the user installs and executes client software on their device. The client software provides the VoIP connections as well as other functions such as registration and authentication. In addition to voice communication, the client may also provide further features such as video calling, instant messaging (“IM”), SMS messaging, file transfer and voicemail.

One type of communication system for packet-based communication uses a peer-to-peer (“P2P”) topology. To enable access to a peer-to-peer system, a user must execute P2P client software provided by a P2P software provider on their computer, and register with the P2P system. When the user registers with the P2P system, the client software is provided with a digital certificate from a server. Once the client software has been provided with the certificate, then calls or other communications can subsequently be set up and routed between users of the P2P system without the further use of a server in the set-up. Instead, the client looks up the required IP addresses from information distributed amongst the P2P client software on other end users' computers within the P2P system. Once the IP address of a callee's terminal has thus been determined, the caller's P2P client software then exchanges certificates with the callee's P2P client software. The exchange of the digital certificates (or user identity certificates, “UIC”) between users provides proof of the users' identities and that they are suitably authorised and authenticated in the P2P system. Therefore, the presentation of digital certificates provides trust in the identity of the users.

It is therefore a characteristic of peer-to-peer communication that, once registered, the users can set up their own communication routes through the P2P system in a decentralized manner based on distributed address look-up and the exchange of one or more digital certificates, without using a server for those purposes. Further details on such a P2P system are disclosed in WO 2005/008524 and WO 2005/009019.

VoIP or other packet-based communications can also be implemented using non-P2P systems that do use centralized call set-up.

### SUMMARY

One aim in relation to packet-based communications such as P2P is to make them more readily accessible. Whilst the communication client may be very user-friendly, users may still spend more time using other more familiar functionality of their terminal. Thus it would be desirable to integrate features relating to the packet-based communications to some extent with such other functionality.

According to one aspect of the present invention, there is provided a method for use in a communication system comprising at least a packet-based network, the method comprising: receiving names of users of the communication system retrieved from a first storage unit; and interacting with a document-browser application executed on a first user terminal, the document browser being configured to retrieve an electronic document from a second storage unit and display it on a screen, the document comprising at least a portion of text; wherein said interaction comprises analysing the text of the retrieved document in order to match one or more of said names with one or more respective corresponding text strings in said document, and displaying presence information in conjunction with the document to indicate an availability status of the user corresponding to the matched name.

By thus interacting with document-browser, then packet-based communication can be facilitated via a more familiar or regularly-used working environment for the user, particularly by integration of related presence information into the documents accessed via the document browser.

In embodiments, the method may comprise associating one of the matched names with an address identifying a second user terminal within the communication system, and using said address to communicate with the second user terminal via said packet-based network.

Said retrieval and association of names may be performed by execution of a communication client application on the first user terminal.

Said interaction may be performed by execution of a separate tool-bar application operating in conjunction with the client application. Alternatively said interaction may be performed by execution of said communication client application.

Preferably said interaction further comprises detecting a user input asserted in relation to the displayed presence information for one of said matched text strings, and said communication with the second user terminal is dependent on said user input; such that the displayed presence information can also act as a control providing access to packet-based communications via the communication client application but presented to the user via the document-browser application.

Thus the packet-based communications can advantageously be made more readily accessible to the user, by using the displayed presence information to also provide related controls into the documents accessed via the document browser.

Preferably said interaction further comprises displaying a control in conjunction with the document allowing a choice of communication types for communicating with the second user terminal.

Thus advantageously, the presence information may influence the choice of communication method.

In yet further embodiments, the document-browser application may comprise a document-browser client application and said second storage unit may comprise a server, such that said execution of the document-browser application may comprise executing the document-browser client application to retrieve the electronic document from the server via the packet-based network and display it on the screen.

The presence information may be displayed in co-location with the corresponding text-strings in said document.

Said first storage unit may comprise a remote storage device, such that said retrieval of names may comprise retrieving the names from the remote storage device via the packet-based network.

Said remote storage device may comprise a server, such that said retrieval of names may comprise retrieving the names from that server via the packet-based network.

Said address may comprise an IP address

The communication system may further comprise at least one of a fixed-line circuit-switched telephone network and a mobile cellular telephone network coupled to the packet-switched network via a gateway, and said address may comprise a telephone number for one of the fixed-line circuit-switched telephone network and the mobile telephone network, in which case the second user terminal is a corresponding one of a fixed-line telephone and mobile telephone respectively and the bidirectional communication channel is established via the packet-based network, gateway and the one of the fixed-line circuit-switched telephone network and mobile cellular telephone network.

The document may be a webpage and the document browser application may be a web client application.

Said names may be contacts of the user of the first terminal.

The packet-based network may comprise the Internet.

The communication client application may comprise a peer-to-peer client application, and the communication with the second user terminal may be performed by peer-to-peer set-up.

The communication with the second user terminal may be by establishment of a bidirectional communication channel, which may comprise establishing one of a voice call, video call and instant messaging session.

According to another aspect of the present invention, there is provided a computer program product for use in communicating over a communication system comprising at least a packet-based network, the program being embodied on a computer-readable medium and comprising code configured so as when executed on a first user terminal to: receive names of users of the communication system retrieved from a second storage unit; interact with a document-browser application also executed on the first user terminal, wherein said interaction comprising matching one or more of said names with one or more respective corresponding text strings in an electronic document retrieved by the document-browser application from a first storage unit, and displaying presence information in conjunction with the document to indicate an availability status of the user corresponding to the matched name.

This program could be a toolbar application, a stand-alone client application, an application having the functionality of both, or other software relating to communications over a communication system comprising at least a packet-based network.

The code of the program may be further configured to perform any of the relevant method steps above.

According to another aspect of the present invention, there is provided a method of establishing communications over a communication system comprising at least a packet-based network, the method comprising: on a first user terminal, executing a document-browser application to retrieve an electronic document from a first storage unit and display it on a screen, the document comprising at least a portion of text; on the first user terminal, executing communication software for use in communicating with other user terminals via the packet-based network; wherein the execution of the communication software comprises retrieving names of users of the communication system from a second storage unit and interacting with the document-browser application, said interaction comprising matching one or more of said names with one or more respective corresponding text strings in said document and displaying presence information in conjunction with the document to indicate an availability status of the user corresponding to the matched name; and wherein the execution of the communication software further comprises associating one of the matched names with an address identifying a second user terminal within the communication system, and using said address to communicate with the second user terminal via said packet-based network.

According to a further aspect of the present invention, there is provided a communication system comprising: a packet-based network; and a plurality of user terminals of the packet-based network each comprising a processor, storage device and screen, wherein at least one of the user terminals has installed in its storage device so as to be arranged for execution by the processor: a document-browser application operable to retrieve an electronic document from a first storage unit and display it on the screen, the document comprising at least a portion of text; and communication software for use in communicating with other user terminals via the packet-based network; wherein the communication software is configured to retrieve names of users of the communication system from a second storage unit and interact with the document-browser application, said interaction comprising matching one or more of said names with one or more respective corresponding text strings in said document and displaying presence information in conjunction with the document to indicate an availability status of the user corresponding to the matched name.

The communication system may be further configured in accordance with any of the above method steps.

### BRIEF DESCRIPTION OF THE DRAWINGS

For a better understanding of the present invention and to show how it may be carried into effect, reference will now be made by way of example to the accompanying drawings in which:

FIG. 1 is a schematic representation of a network such as the Internet;

FIG. 2 is a schematic block diagram of a user terminal installed with a web-client application, P2P client application and related toolbar application;

FIG. 3 is a schematic representation of a P2P client application user interface;

FIG. 4a is a schematic representation of a web client application user interface;

FIG. 4b is a schematic representation of a web client application user interface with functionality incorporated from a toolbar application;

FIG. 4c is another schematic representation of a web client application user interface with functionality incorporated from the toolbar application; and

FIG. 5 is a flow chart of a communication method.

### DETAILED DESCRIPTION

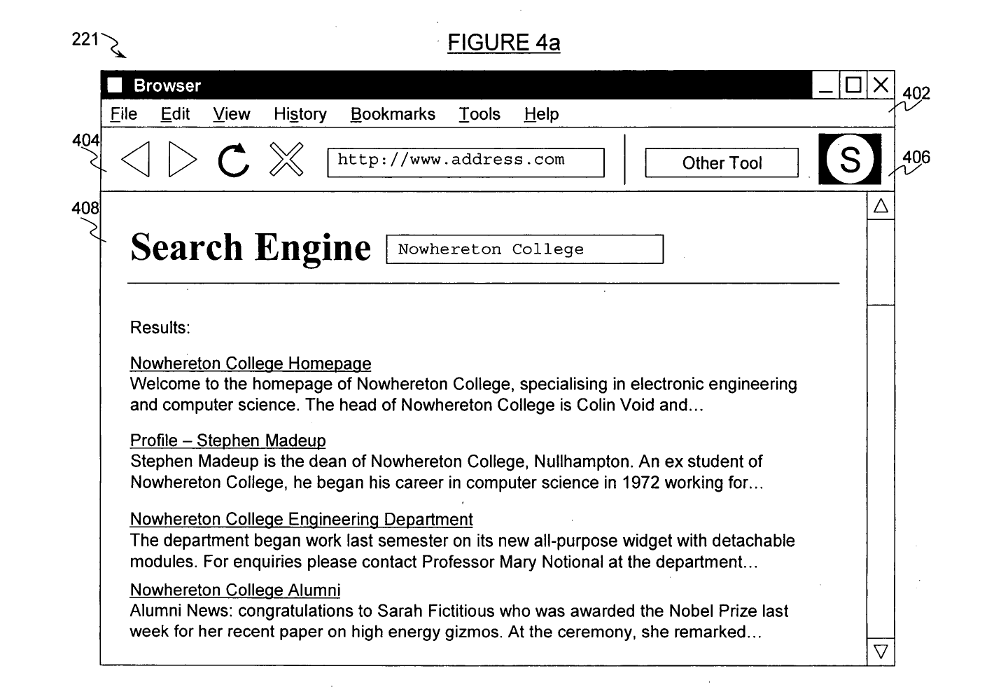

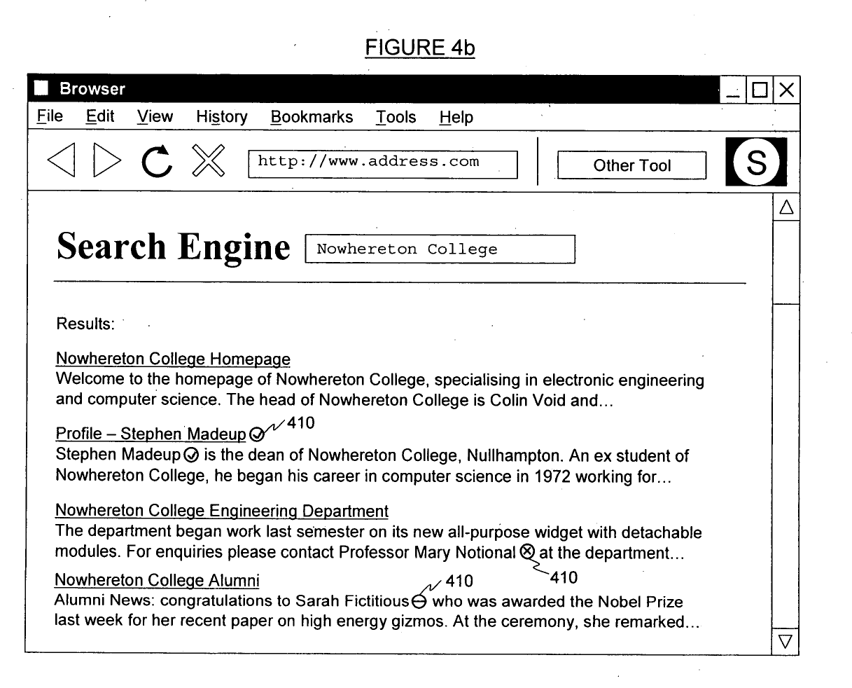

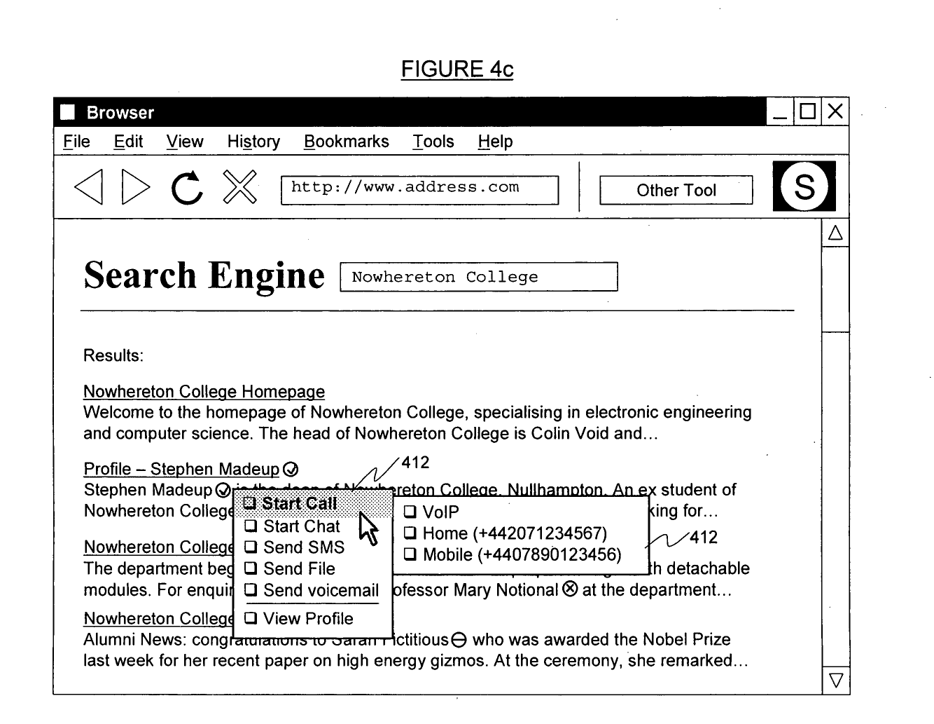

In preferred embodiments, the present invention retrieves presence status for names on a webpage that correspond to names in the user's P2P contact list. As shown schematically in FIG. 4b, presence status icons 410 are inserted into the webpage so that the user can easily see when contacts identified on the webpage are online or available. As shown in FIG. 4c, the user can then use an icon inserted into the webpage to initiate a call or other action with the user via the webpage. These figures will be discussed in more detail later.

By inserting presence information into the webpage, the webpage is thereby manipulated such that the user can immediately identify the contacts availability to talk or engage in other communications. The icon may also act as a control which can be used, for example, to either start a call or leave a voicemail—the contact's presence information may influence the user's choice of communication method.

Thus P2P or other packet-based communications are advantageously made more readily accessible to the user, by integration of related information and/or controls into a more familiar or regularly-used working environment for the user.

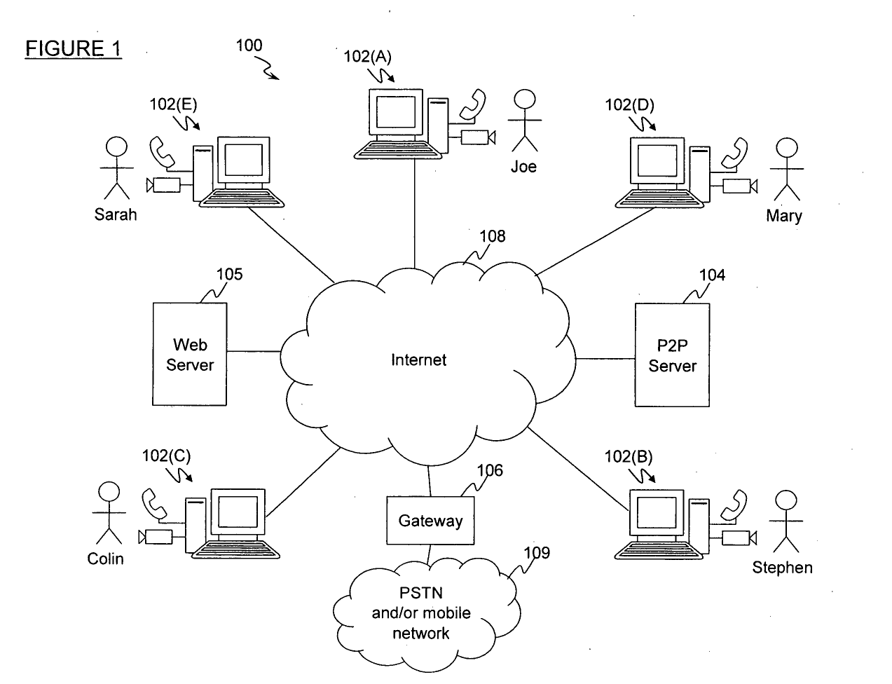

FIG. 1 is a schematic illustration of a communication system 100. The communication system 100 includes at least a packet-based network such as the Internet, which comprises a plurality of interconnected elements such as those labelled 102, 104, 105 and 106. Each network element is inter-coupled with the rest of the Internet 108, and is configured to communicate data with other such elements over the Internet by transmitting and receiving data in the form of Internet Protocol (IP) packets. Each element also has an associated IP address locating it within the Internet. The elements shown explicitly in FIG. 1 are: a plurality of end-user terminals 102(A) to 102(E) such as desktop or laptop PCs or Internet-enabled mobile phones; one or more P2P servers 104; one or more web servers 105; and a gateway 106 to another type of network 109 such as to a traditional Public-Switched Telephone Network (PSTN) or other circuit switched network, and/or to a mobile cellular network. However, it will of course be appreciated that many more elements make up the Internet than those explicitly shown. This is represented schematically in FIG. 1 by a communications cloud 108 which will include many other end-user terminals, servers and gateways, as well as routers of Internet service providers (ISPs) and Internet backbone routers.

Each of a plurality of the end-user terminals 102 is installed with communication software, in embodiments comprising a P2P client application and a related P2P toolbar application (to be described later). When executed, this allows the end-user terminals 102 to establish bidirectional communication channels with other such end-user terminals 102 via the Internet using P2P call set-up (or more generally connection set-up). The P2P client applications also share presence information with one another, which provides an availability status of users. The presence information for each user is preferably at least in part defined by the user themselves. To supplement the decentralized call set-up, the P2P client application may retrieve some additional information from the P2P server 104, such as contact lists which provide the names of the users' contacts, “avatars” which are images chosen by users to represent themselves within the P2P system.

Each of the end-user terminals 102 is also installed with document-browser client software, in embodiments in the form of a web browser. When executed, this allows the end-user terminals 102 to retrieve electronic documents in the form or webpages from the web server(s) 105 and display them on their screens under control of the user.

A P2P client application may also be installed at one or more gateways 106 coupled to both the Internet 108 and one or more other networks 109 such as a PSTN network and/or a mobile cellular network. This allows the P2P client applications running on end-user terminals 102 to communicate with ordinary land-line telephones and/or mobile telephones respectively, even if those telephones themselves do not run P2P client applications and are not directly coupled to the Internet. In that case, the P2P client application on the terminal 102 sets up a connection over the Internet with the P2P client application on the gateway 106 using P2P call set-up and provides it with a phone number, and the gateway 106 uses the phone number to set up a connection with the telephone over the respective other network. Or in the other direction, a telephone user may dial into the gateway 106 with a number that identifies the user within the P2P system, and the gateway 106 will set up a connection with that user's terminal 102 over the Internet. In either case, a bidirectional communication channel can thus be established via the Internet and PSTN or mobile cellular network.

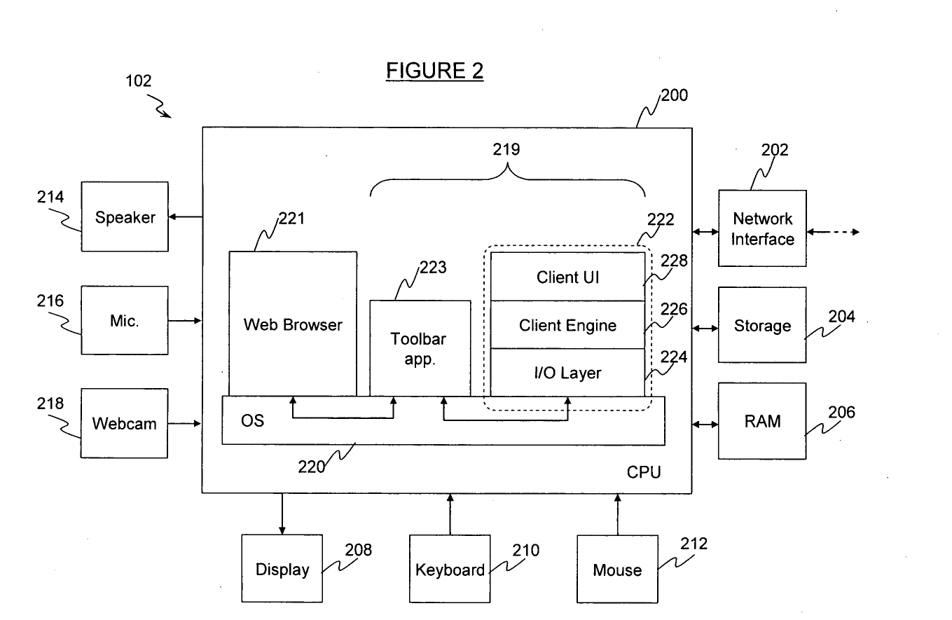

The schematic block diagram of FIG. 2 shows an example of an end-user terminal 102, which is configured to act as a terminal of a P2P system operating over the Internet. The terminal 102 comprises a CPU 200 operatively coupled to: a network interface 202 such as modem for connecting to the Internet 100, a non-volatile storage device 204 such as a hard-drive or flash memory, and a volatile memory device such as a random access memory (RAM) 206. The terminal 102 also comprises one or more user input devices, for example in the form of a keyboard 210, mouse 208, microphone 216 and webcam 218, each operatively coupled to the CPU 200. The terminal 102 further comprises one or more user output devices, for example in the form of a display screen 208 and speaker 214, again each operatively coupled to the CPU 200.

The storage device 204 stores software including at least an operating system (OS) 220, a document-browser client application in the form of a web browser 221, and packet-based communication software 219 comprising a P2P client application 222 and a related P2P toolbar application 223. On start-up or reset of the terminal 102, the operating system software 220 is automatically loaded into the RAM 206 and from there is run by being executed on the CPU 200. Once running, the operating system 220 can then run applications such as the web client application 221, P2P client application 222 and toolbar application 223 by loading them into the into the RAM 206 and executing them on the CPU 200. To represent this schematically in FIG. 2, the operating system 220, web client application 221, P2P client application 222 and toolbar application 223 are shown within the CPU 200.

The P2P client application 222 comprises three basic layers: an input and output (I/O) layer 224, a client engine layer 226, and a user interface (UI) layer 228. The web client application 221, P2P client application 222 and P2P toolbar application 223 are run “on” the operating system 220. This means that in a multi-tasking environment they are scheduled for execution by the operating system 220; and further that inputs to the web client application 221 and the lowest (I/O) layer 224 of the P2P client application 222 from the input devices 202, 216 and 218 as well as outputs from web client application 221 and the I/O layer 224 of the P2P client application 222 to the output devices 202, 208 and 214 may be mediated via suitable drivers and/or APIs of the operating system 220.

The I/O layer 224 of the P2P client application comprises audio and/or video codecs which receive incoming encoded streams and decodes them for output to speaker 214 and/or display 208 as appropriate, and which receive unencoded audio and/or video data from the microphone 216 and/or webcam 218 and encodes them for transmission as streams to other end-user terminals 102 of the P2P system. The I/O layer 224 may also comprises a control signalling protocol for signalling control information between terminals 102 of the network.

The client engine 226 then handles the connection management functions of the P2P system as discussed above, such as establishing calls or other connections by P2P address look-up and authentication. The client engine may also be responsible for other secondary functions of the P2P system such as supplying up-to-date contact lists and/or avatar images of the user to the P2P server 104; or retrieving up-to-date contact lists of the user and retrieving up-to-date avatar images of other users from the P2P server 104. Further, the client engine retrieves presence information from the other clients of the users in the contact list via a public API, and reciprocally provide its own presence information to those other clients that are online. Exchange of presence information directly between clients via a public API is the preferred option, but alternatively the presence information could be exchanged via an intermediate node such as a server 104.

The UI layer 228 is responsible for presenting decoded video to the user via the display 208, for how to arrange the presented output on the display 208 along with user controls such as buttons and menus, and for receiving inputs from the user via the presented controls.

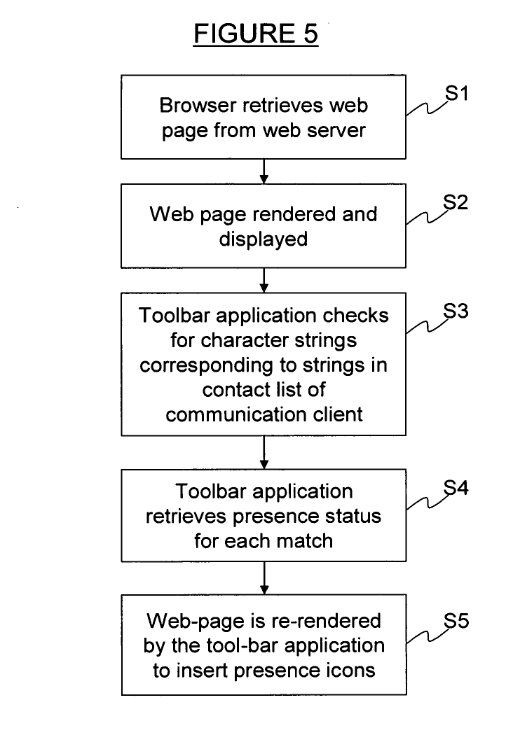

The I/O layer 224 of the P2P client application 222 is arranged to be able to interact with the P2P toolbar application 223 and the toolbar application 223 is arranged to be able to interact with the web client application 221, preferably all under control of the OS 220. This interaction will be discussed in more detail below in relation to FIGS. 4a-5.

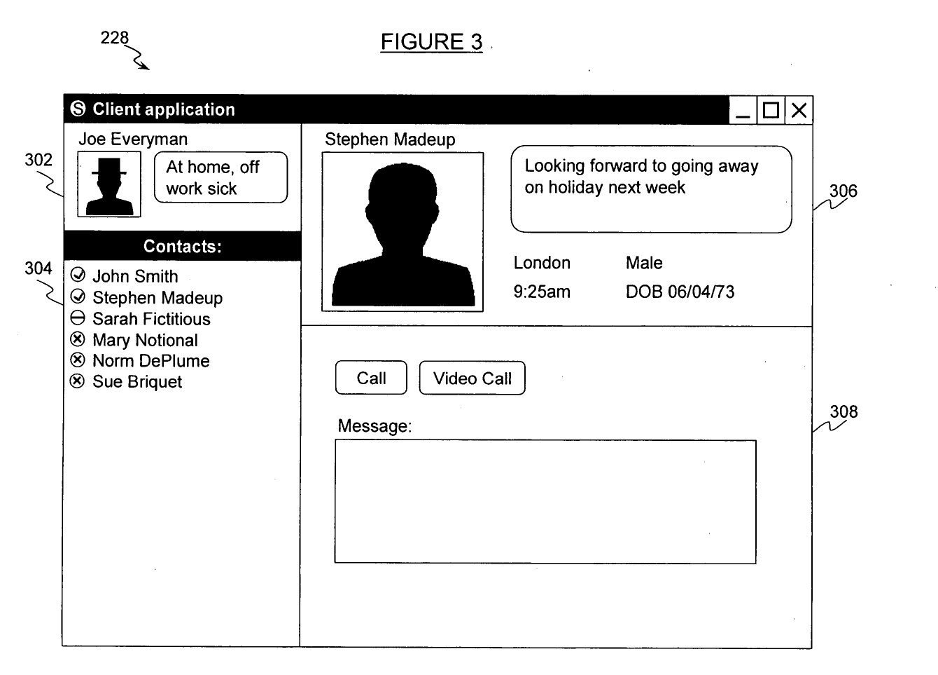

FIG. 3 illustrates schematically an example user interface 228 as would be presented to a user on the display 208 when the P2P client application 222 is open for viewing by the user. In this example, the user interface 228 is that of the P2P client application 222 running on a first terminal 102(A). The user interface is divided into a number of panels. A first panel 302 displays some details of the user's own profile, in this example the user's name “Joe Everyman”, an avatar image, and a “mood message”. These details may be stored at and retrieved from the P2P server 104 by the client engine 226, so as to be made available to other users of the P2P network. The avatar image is an image chosen by the user to represent themselves to other users (which need not necessarily be a photo of themselves). The mood message is a brief user-defined statement which can be used for any purpose but is typically used to express how the user is feeling, news about recent events in the user's life, or any upcoming plans that may affect the user's availability (the mood message may therefore in some cases be considered a type of presence information). When other users view Joe's profile in their own clients, these details will be visible to them via the P2P server 104, and vice versa the other users' details will be made available to Joe's client (if they are in each others' contact lists).

A second panel 304 of the user interface 228 displays a contact list of the user's friends or associates, these being other users of the P2P network. Entry in the contact list is preferably conditional on agreement from the users. The contact list may be stored at and retrieved from the P2P server by the client engine 226, so that the same list is available to the user if running a P2P client application 222 on different terminals. Presence information is also displayed in the panel next to each contact. The presence information represents an availability status which preferably comprises an indication of whether the user is online, and preferably is in part user-defined. For example, the presence status may be: the user is offline (x), the user is online and has selected to be shown as available (√), or the user is online but has selected to be shown as not available (−).

A third panel 306 of the user interface 228 displays the profile of a selected user from the contact list, in this case “Stephen Madeup”, a user of a second end-user terminal 102(B). The displayed profile includes Stephen's name, avatar image and mood message, along with other details Stephen may have supplied to the P2P server 104 such as current location, local time, gender and date of birth (DOB). These profile details are retrieved from the P2P server 104 by the client engine 226.

A fourth panel 308 of the user interface 228 then displays communication controls in relation to the selected contact, such as buttons allowing a voice or video call to be established, and a window for entering chat messages. Any incoming chat messages and chat history will be displayed in this panel also, and file transfers may be established by dragging-and-dropping files into the chat window.

FIG. 4a illustrates schematically an example user interface of the web client application 221 as would be seen when open for viewing on display 208. This user interface comprises menus for accessing 402 various functions of the browser. The user interface also comprises navigation controls 404 allowing the user to access and navigate between different webpages, such as back, forward, refresh and stop controls and/or an address bar for entering web addresses. Thus the user is able to select which website to retrieve and display from one or more web servers 105. The user interface also comprises a display of the actual selected webpage itself 408. The website comprises at least a portion of text.

The user interface further comprises one or more toolbars 406 showing an indication of one or more toolbar applications running in conjunction with the web client 221. The toolbars may also include controls allowing the user to access the toolbar applications or functions of them, which the user can thus select or control via the web client's user interface. In embodiments, the communication software 219 may comprise one such toolbar application 223 which can be run in conjunction with the web client 221, indicated by the “S” in FIG. 4c which indicates to the user at least that the P2P toolbar application 223 is running, and may also allow access to the P2P client 222 of functions thereof when clicked. Further, the toolbar application 223 is able to communicate data to and from both of the web client 221 and P2P client application 222, in embodiments via the OS 220. Even when the user interface 228 of the P2P client application 222 is not open for viewing on the display 208, the toolbar application 223 may still be running and interacting with the web client application 221, and may allow the P2P client application 222 to be launched via the user interface of the web client 221.

A particularly advantageous use of this interaction between toolbar, P2P client and web client is now described in relation to FIG. 4b. The P2P toolbar application 223 interacts with the web client 221 in order to read the text data from the webpage currently selected by the user for viewing. The P2P toolbar application 223 also interacts with the P2P client 221 to receive a list of names of contacts which it has retrieved from P2P server 104. The P2P toolbar application 223 then scans the text of the webpage for strings that match the name. Wherever it finds a match, it requests presence information for the matched contact from the P2P client application 222 and inserts a presence icon 410 in the displayed webpage representing the presence status of that contact in co-location with their name, preferably immediately after the name on the same line of text. This is preferably done by re-rendering the screen, but could alternatively be done by an overlay.

Thus instead of viewing the P2P-related presence information via the user interface 228 of the P2P client 222, the user is able to view it via the user interface of the web client 221 in a convenient, readily-identifiable manner.

For instance, in the example of FIG. 4b the user has accessed a search engine in the web client 221 and has thereby summoned certain search results comprising links to other webpages along with corresponding extracts of the text from those pages. The P2P toolbar application 223 scans the displayed text to determine whether it recognises any as contacts. In doing so, it does not recognise “Colin Void”, a user of a third terminal 102(C) of the P2P system, because Colin is not in Joe's contact list (they have not agreed to be contacts with one another). However, it does recognise “Stephen Madeup” because he is a contact of Joe's, and therefore displays Stephen's presence status (available) in the form of an icon 410 (√) wherever Stephen's name appears on the displayed part of the page. It also recognises two other names as contacts, “Mary Notional” and “Sarah Fictitious”, users of fourth and fifth terminals 102(D) and 102(E) of the P2P system respectively. The P2P client toolbar application 222 therefore also inserts presence status icons 410 next to their names, in this example to indicate that Mary is offline (x) and Sarah is online but has chosen to be shown as unavailable (−).

Note that a “match” need not necessarily mean an exact verbatim match: in some embodiments that could be required, but in other embodiments could also include for example the possibility of recognising a part of a name, a variant of a name, or an alias. Nonetheless, note that a name is specifically a term for designating an actual person and must comprise letters of an alphabet (not necessarily a Western alphabet). The term “text” is also used herein in the sense of something comprising letters of an alphabet. Therefore matching text to a name cannot simply amount to recognising a substantially numerical address or ID for a user, such as recognising a phone number. That would not fall under the function of matching a name. A name could still include a numerical element, but only as a part.

As illustrated schematically in FIG. 4c, the presence icons preferably also act as controls allowing the user to initiate packet-based communications with the contacts via the P2P client 222. In the example of FIG. 4c, the user summons one or more menus 412 by clicking on a contact's presence icon. These may provide the options of initiating different types of communication such as voice call, video call, IM chat session, SMS, file transfer, or voicemail. If the contact has more than one terminal, the menus 412 may also provide options as to which terminal to contact. These could correspond to terminals accessed via different networks, such as VoIP only communication over the Internet between two terminals 102 of the P2P system, communication with a land-line telephone via a PSTN or other circuit-switched network, or communication with a mobile telephone via a mobile cellular network. The control may also provide the option of viewing the contact's profile. When the user clicks on one of the controls, the P2P toolbar application 223 signals to the P2P client application 222 to initiate the relevant action.

Thus instead of accessing the P2P communications via the user interface 228 of the P2P client 222, the user is able to access them via the user interface of the web client 221.

Note that there may be a difference between a user's actual name and their username, both of which are distinct from their address. For example, the contact Stephen's details may be:

Actual name: Stephen Madeup

Username: stephen_madeup901

IP address: 123.45.678.90

One difference is that the username must be unique within the P2P system or other communication system in question, whereas the actual name need not be unique. The username identifies the user themselves within the P2P system, whereas the address locates the user's terminal. The P2P toolbar application 223 matches the actual name against the text in the document, then looks up the IP address corresponding to that name. This process could involve an intermediate step of using the contact list to determine which username maps to the actual name and then looking up the IP address using the username. The IP address loop-up is preferably performed according to P2P principles, i.e. based on information distributed amongst end-user terminals 102 and not looked up from a central server. Alternatively or additionally, the P2P toolbar application 223 could match usernames directly with text strings in the webpage.

Further, note that some users' address details may comprise a telephone number and a corresponding address of a suitable gateway 106. Further, if in some embodiments it is not necessary for a user to be a user of the P2P system to be listed as a contact, then that user need not necessarily have a username for that P2P system. For example a user's details could be of the form:

Actual name: John Smith

Username: [none]

Gateway IP address: 098.76.543.21

PSTN address (i.e. phone number): +441234123456

A preferred method of inserting presence status information and related controls into a webpage is now described in relation to FIG. 5.

At step S1, the browser retrieves a web page from web server. At step S2, the webpage rendered and displayed by the browser. At step S3, the toolbar application checks for character strings corresponding to character strings in contact list of communication client—therefore the communication client should preferably be running. At step S4, the toolbar application retrieves presence status for each match. At step S5, the webpage is re-rendered by the toolbar application to insert a presence icon into webpage corresponding to presence status. The icon is clickable to reveal drop down menu as shown for example in FIG. 4c.

It will be appreciated that the above embodiments are described only by way of example.

For instance, although the above has been described mainly in terms of a peer-to-peer (P2P) network, the present invention is not specific to P2P and may be applied to any kind of packet-based communications. Further, the present invention is not limited to use over the Internet, but could be implemented over any packet-based network.

Although the above has been described in terms of a web browser and webpages, the present invention is not specific to the web and can more generally apply to any documents accessed from a server by means of any document-browser client software, or more generally even any documents or user-interface displayed on the client computer—names can occur also in documents that were opened from a local storage unit, not necessarily just from a server. For example, the invention could recognise names in word-processing documents.

Further, the names of users need not be retrieved from a server, but could instead be retrieved from a local storage unit or a distributed list on one or more remote user terminals. In the case where both the document and the user names are local, the respective storage units may be different areas of the same storage device. Further, the invention is not limited to displaying the above-described presence icons nor any particulate manner of presenting information or user controls, but can more generally be used to provide any kind of presence information in relation to any kind of communications based on names matched from the retrieved document.

Note also that the term “document” as used herein does not imply any limitation to the purpose of the document. For example, an html document could comprise an application, such as an online CRM system, networking site or many others.

Further, although the toolbar application and P2P client application have been described above as separate applications, and in preferred embodiments are provided as separately executable applications, in other embodiments they need not be separate and could be incorporated together into the same executable program, and/or even if having any degree of independence they could still be considered together as different parts of the same overall communication client application. Generally speaking, the term “application” as used herein need not necessarily refer to any particular discrete unit of software such as a single or separately executable program. Any functionality described above as a particular application could comprise one or more distinct or independently operable portions of code. Further, although in preferred embodiments the document browser and communication client are separately executable applications, again they need not necessarily be.

Other applications and configurations may of the present invention be apparent to the person skilled in the art given the disclosure herein. The scope of the invention is not limited by the described embodiments, but only by the appended claims.

What is claimed is:

1. A method for use in a communication system comprising at least a packet-based network, the method comprising:
receiving names of users of the communication system retrieved from a first storage unit; and
interacting with a document-browser application executed on a first user terminal, the document browser being configured to retrieve an electronic document from a second storage unit and display it on a screen, the document comprising at least a portion of text;
wherein said interaction comprises analysing the text of the retrieved document in order to match one or more of said names with one or more respective corresponding text strings in said document, and displaying presence information in conjunction with the document to indicate an availability status of the user corresponding to the matched name.

2. The method of claim 1, further comprising: associating one of the matched names with an address identifying a second user terminal within the communication system, and using said address to communicate with the second user terminal via said packet-based network.

3. The method of claim 2, wherein said retrieval and association of names is performed by execution of a communication client application on the first user terminal.

4. The method of claim 3, wherein said interaction is performed by execution of a separate toolbar application operating in conjunction with the client application.

5. The method of claim 3, wherein said interaction is performed by execution of said communication client application.

6. The method of claim 1, wherein the document-browser application comprises a document-browser client application and said second storage unit comprises a server, such that said execution of the document-browser application comprises executing the document-browser client application to retrieve the electronic document from that server via the packet-based network and display it on the screen.

7. The method of claim 1, wherein the presence information is displayed in co-location with the corresponding text-strings in said document.

8. The method of claim 3, wherein said interaction further comprises detecting a user input asserted in relation to the displayed presence information for one of said matched text strings, and communication with the second user terminal is dependent on said user input; such that the displayed presence information also acts as a control providing access to packet-based communication via the communication client application but presented to the user via the document-browser application.

9. The method of claim 1, wherein said interaction further comprises displaying a control in conjunction with the document allowing a choice of communication types for communicating with the second user terminal.

10. The method of claim 1, wherein said first storage unit comprises a remote storage device, such that said retrieval of names comprises retrieving the names from the remote storage device via the packet-based network.

11. The method of claim 10, wherein said remote storage device comprises a server, such that said retrieval of names comprises retrieving the names from that server via the packet-based network.

12. The method of claim 1, wherein said address comprises an IP address.

13. The method of claim 1, wherein the communication system further comprises at least one of a fixed-line circuit-switched telephone network and a mobile cellular telephone network coupled to the packet-switched network via a gateway, and said address comprises a telephone number for one of the fixed-line circuit-switched telephone network and the mobile telephone network, the second user terminal being a corresponding one of a fixed-line telephone and mobile telephone respectively and the bidirectional communication channel being established via the packet-based network, gateway and the one of the fixed-line circuit-switched telephone network and mobile cellular telephone network.

14. The method of claim 6, wherein the document is a webpage and document browser application is a web client application.

15. The method of claim 1, where said names are contacts of the user of the first terminal.

16. The method of claim 1, wherein the packet-based network comprises the Internet.

17. The method of claim 3, wherein the communication client application comprises a peer-to-peer client application, and is the communication with the second user terminal is established by peer-to-peer set-up.

18. The method of claim 2, wherein the communication with the second user terminal comprises establishing a bidirectional communication channel with the second user terminal, the bidirectional channel comprising one of a voice call, video call and instant messaging session.

19. A computer program product for use in communicating over a communication system comprising at least a packet-based network, the program being embodied on a computer-readable medium and comprising code configured so as when executed on a first user terminal to:
receive names of users of the communication system retrieved from a second storage unit;
interact with a document-browser application also executed on the first user terminal, wherein said interaction comprising matching one or more of said names with one or more respective corresponding text strings in an electronic document retrieved by the document-browser application from a first storage unit, and displaying presence information in conjunction with the document to indicate an availability status of the user corresponding to the matched name.

20. A communication system comprising:
a packet-based network; and
a plurality of user terminals of the packet-based network each comprising a processor, storage device and screen, wherein at least one of the user terminals has installed in its storage device so as to be arranged for execution by the processor:
a document-browser application operable to retrieve an electronic document from a first storage unit and display it on the screen, the document comprising at least a portion of text; and
communication software for use in communicating with other user terminals via the packet-based network;
wherein the communication software is configured to retrieve names of users of the communication system from a second storage unit and interact with the document-browser application, said interaction comprising matching one or more of said names with one or more respective corresponding text strings in said document and displaying presence information in conjunction with the document to indicate an availability status of the user corresponding to the matched name.

21. The system of claim 21, wherein the communication software is operable to associate one of the matched names with an address identifying a second user terminal within the communication system, and use said address to communicate with the second user terminal via said packet-based network.

22. The system of claim 21, wherein said communication software comprises a communication client application configured to perform said retrieval and association, and a separately executable toolbar application configured to perform said interaction with the document-browser application.

23. The system of claim 20, wherein the first storage unit comprises a first server of the packet-based network, and the document-browser application comprises a document-browser client application operable to retrieve the electronic document from the first server via the packet-based network and display it on the screen.

24. The system of claim 21, wherein said interaction further comprises detecting a user input asserted in relation to the displayed presence information for one of said matched text strings, and said communication with the second user terminal is dependent on said user input; such that the displayed presence information also acts as a control providing access to packet-based communications established via the communication software but presented to the user via the document-browser application.

25. The system of claim 21, wherein said interaction further comprises displaying a control in conjunction with the document allowing a choice of communication types for communicating with the second user terminal.

26. The system of claim 21, wherein the second storage unit comprises a remote storage device, such that said retrieval of names comprises retrieving the names from the remote storage device via the packet-based network.

27. A method of establishing communications over a communication system comprising at least a packet-based network, the method comprising:
on a first user terminal, executing a document-browser application to retrieve an electronic document from a first storage unit and display it on a screen, the document comprising at least a portion of text;
on the first user terminal, executing communication software for use in communicating with other user terminals via the packet-based network;
wherein the execution of the communication software comprises retrieving names of users of the communication system from a second storage unit and interacting with the document-browser application, said interaction comprising matching one or more of said names with one or more respective corresponding text strings in said document and displaying presence information in conjunction with the document to indicate an availability status of the user corresponding to the matched name; and
wherein the execution of the communication software further comprises associating one of the matched names with an address identifying a second user terminal within the communication system, and using said address to communicate with the second user terminal via said packet-based network.
